(19) United States
(12) Patent Application Publication
(10) Pub. No.: US 2024/0059533 A1
(43) Pub. Date: Feb. 22, 2024

(54) LEVER HOIST

(71) Applicant: COLUMBUS MCKINNON INDUSTRIAL PRODUCTS GMBH, Wuppertal (DE)

(72) Inventors: Detlef STRUCK, Wuppertal (DE); Wolfram SCHNEEBECK, Wuppertal (DE)

(21) Appl. No.: 18/267,335

(22) PCT Filed: Dec. 17, 2020
(86) PCT No.: PCT/DE2020/101076

§ 371 Date: Jun. 14, 2023

(51) Int. Cl. B66D 3/14; B66D 5/22

(52) U.S. Cl. CPC B66D 3/14; B66D 5/22

(57) ABSTRACT

A lever hoist including a housing, in which a load chain wheel and a drive shaft are rotatably mounted. A drive torque is transmittable to the drive shaft via a lever. A load chain is moveable via the load chain wheel. The ratchet wheel has an internal thread and is axially displaceable on a threaded portion of the drive shaft having a brake thread. A damping spring is on a drive-side portion of the drive shaft between the threaded portion and an outer stop. If the load chain is blocked, when the load no longer continues to slip in a sliding manner, the ratchet wheel is pushed against the pressure of the damping spring until the pawl body is displaced out of the drive teeth into the untoothed disengagement portion.

### RELATED APPLICATIONS

The present application claims priority of PCT/DE2020/101076 filed Dec. 17, 2020, the disclosure of which is hereby incorporated by reference herein in its entirety.

### FIELD

The disclosure relates to a lever hoist. A lever hoist uses round steel chains as support means or traction means and serves for lifting, lowering and pulling loads. The present disclosure relates to a manually actuated lever hoist in which the lifting movement is generated by a lever by manual operation.

### BACKGROUND

A lever-actuated lifting gear which also is denoted as a traction hoist or chain hoist is described in DE 41 05 050 C2. The lifting gear has a support hook as an upper fastening element and a load hook as a lower stop element. The upper fastening element and the lower stop element are connected together indirectly via a housing. The stop element is connected via a load chain as traction means to a traction drive, which is located in the housing of the lifting gear. The traction drive is able to be set in rotation inside the housing by a pivoting movement of a hand lever. The lever arm engages in a gear apparatus which in turn is connected to the traction drive. In this manner, an object is able to be displaced or tied down.

In addition to a drive with a switchable ratchet mechanism, the traction drive includes a load pressure brake, a load chain wheel and a gear mechanism, wherein the gear mechanism is frequently configured as a planetary gear mechanism. The hand lever and the ratchet wheel of the ratchet mechanism are located at one end of a drive shaft which passes through the load pressure brake and the load chain wheel. The gear mechanism is located at the other end of the drive shaft, the gear mechanism thus being connected to the load chain wheel in a torque transmitting manner.

The load pressure brake is made up of a ratchet wheel disk, which is provided on an outer circumference of the load pressure brake, the outer circumference with recesses or teeth, two friction elements, friction disks or friction linings, located on either side of the ratchet wheel disk, and two pawls which are articulated to the housing and which are pushed against the ratchet wheel disk by the action of ratchet hook springs. The two friction elements come into a frictional connection, on the one hand, with the ratchet wheel disk and, on the other hand, with a pressure disk fixed to the shaft or with the ratchet wheel. The ratchet wheel has an internal thread and is axially displaceable thereby on a threaded portion of the drive shaft which has an external thread. The external thread has a relatively large thread pitch, whereby the ratchet wheel is able to be easily screwed relative to the drive shaft. The external thread is also denoted as a movement thread or as a brake thread since the external thread forms part of the load pressure brake. The term brake thread is used hereinafter.

The task of the load pressure brake is to keep the load supported by the lifting gear at the respective height or position when the ratchet wheel is stationary. The ratchet wheel is then pushed via the ratchet wheel disk and the integrated friction elements against the pressure disk. The pawls are located in the circumferential recesses of the ratchet wheel disk. If the ratchet wheel is rotated in the lifting direction, the pawls slide over the teeth of the ratchet wheel disk until the ratchet wheel comes to a standstill. Then the pawls are latched again into the recesses of the ratchet wheel disk. When the load is lowered, the ratchet wheel is rotated in the opposing direction, whereby the ratchet wheel slides axially on the brake thread of the drive shaft and the frictional contact with the friction elements of the ratchet wheel disk and the pressure disk is released. The load is able to be lowered until the shaft, which continues to rotate, compensates again for the axial play.

A lever hoist comprising a freewheel apparatus and an automatically acting load pressure brake is also included in DE 33 23 110 C2.

In a lever hoist, the load torque is transmitted via the drive shaft to the load pressure brake. The relative rotation between the drive shaft and the ratchet wheel leads to an axial force by means of the brake thread, the ratchet wheel disk being clamped thereby between the pressure disk and the ratchet wheel. In order to release the load pressure brake, the hand lever engages by means of a pawl body, such as a pawl rod, in the drive teeth of the ratchet wheel. An axial displacement of the ratchet wheel is achieved by the rotation of the ratchet wheel. As a result, the brake torque is reduced or eliminated. The load is able to be lowered until the axial force and the resulting brake torque is built up again.

If the continuous free sliding of the load and thus the continuous closing of the load pressure brake is interrupted, the free sliding is able to lead to a dangerous situation. This is able to result in, for example, from the load chain being knotted or canted, or even in the case of a blockage by a chain lock. If the operator then attempts to lower the load against such a resistance, the ratchet wheel is displaced axially against the end stop of the drive shaft until the ratchet wheel is coupled against rotation and full torque is introduced via the end stop. This is able to lead to damage of the lever hoist, such as to damage of the stop or even the drive shaft.

### SUMMARY

The object of the disclosure is to provide a lever hoist which is improved in terms of safety and operating technology.

The lever hoist includes a housing in which a load chain wheel and a drive shaft, which drives the load chain wheel via a gear mechanism, are rotatably mounted. A drive torque is able to be transmitted to the drive shaft via a lever. A load chain is able to be moved via the load chain wheel. The lever hoist includes a load pressure brake, which has a pressure disk and a ratchet wheel which are arranged on the drive shaft. A ratchet wheel disk which is provided with teeth on its outer circumference is incorporated between the pressure disk and the ratchet wheel. The ratchet wheel has an internal thread and is axially displaceable on a threaded portion of the drive shaft having a brake thread. The ratchet wheel has drive teeth on its outer circumference for the engagement of a pawl body.

In at least one embodiment of the disclosure, the hand lever is able to be decoupled in the case of a dangerous situation as described above, i.e. in the case of a blockage, so that torque can no longer be transmitted and the lever rotates freely. In order to implement this, a damping spring is positioned between the ratchet wheel and an outer stop which permits a greater axial displacement of the ratchet wheel on the drive shaft. The ratchet wheel itself has on the outer circumference, in addition to the drive teeth, a disengagement portion on the pressure disk side. The disengagement portion of the ratchet wheel is freely rotated and without teeth on the outer circumference.

In order to decouple the pawl body and thus the hand lever from engagement with the ratchet wheel, if the load chain is blocked, the ratchet wheel has an untoothed disengagement portion on the outer circumference between the drive teeth and its end on the pressure disk side. The damping spring is arranged on a drive-side portion of the drive shaft, between the threaded portion and an outer stop. The spring force of the damping spring acts counter to the opening movement of the load pressure brake. If the load chain is blocked, when the load no longer continues to slip in a sliding manner, the ratchet wheel is pushed against the pressure of the damping spring until the pawl body is displaced out of the drive teeth into the untoothed disengagement portion. Then torque is no longer transmittable and the lever rotates freely.

The damping spring is positioned between the ratchet wheel or the brake thread and the outer stop, the end stop, and permits an axial displacement of the ratchet wheel and thus the drive teeth which are dimensioned to be sufficiently large that the hand lever and the force-transmitting pawl body is able to be decoupled in the case of a blockage situation, so that the torque transmission is interrupted. In normal operation, the pawl body of the lever engages in the drive teeth and drives the ratchet wheel. When the load does not continue to slip in a sliding manner, the ratchet wheel is displaced against the pressure of the damping spring until the pawl body is displaced out of engagement with the drive teeth into the region of the disengagement portion.

The damping spring is supported with its end oriented toward the brake thread on an inner stop. The inner stop is able to be formed by a supporting ring positioned on the drive shaft. This supporting ring axially bears against or in front of the brake thread. The damping spring is positioned on a smooth longitudinal portion of the drive shaft between the outer stop and the inner stop. The damping spring is a compression spring which is arranged concentrically on the longitudinal portion of the drive shaft.

If the ratchet wheel is displaced counter to the pressure of the damping spring in a blockage situation, the pawl body is forced out of engagement and the handwheel which is connected to the ratchet wheel is also disengaged to the side. An indicator becomes visible when the ratchet wheel is axially displaced counter to the spring force of the damping spring on the drive shaft and the pawl body is disengaged from engagement with the drive teeth. In this manner the incorrect operating state is signaled.

In at least one embodiment, the display is formed by an indicator ring which is arranged on a socket portion of the ratchet wheel. The indicator ring is able to differ in terms of color from the remaining components, and is able to be designed in a signal color or have an outer coating with a signal color. A malfunction, in which the hand lever is decoupled, and is able to be easily identified by the coloring.

By turning the handwheel clockwise, the pawl body and thus the lever is able to be recoupled and the flux of force restored.

In at least one embodiment, the damping spring is able to absorb dynamic shocks, as able to be produced in the case of suddenly occurring blockage states.

The lever hoist according to the disclosure is able to additionally have a safety brake which implements an emergency braking when the load chain wheel spins. The system is also blocked in the case of such an emergency braking, i.e. the application of the safety brake. The damping spring absorbs a considerable part of the impact energy here. Even in the case of such a blockage, the hand lever according to the disclosure is decoupled by the ratchet wheel being displaced counter to the pressure of the damping spring and the pawl body being displaced out of engagement with the drive teeth into the disengagement portion. This is displayed by the indicator, such as the indicator ring. The appearance of the indicator ring is able to be used as a signal for an applied safety brake.

In at least one embodiment, the lever hoist according to the disclosure provides that the lever hoist has a freewheel mechanism, which serves for decoupling the drive shaft from rotation and which is configured to increase the axial spacing between the ratchet wheel and the pressure disk.

The handwheel, which is coupled to the ratchet wheel forms, part of the freewheel mechanism. By actuating the handwheel, the ratchet wheel is able to be axially displaced on the drive shaft and the freewheel set or canceled. In the freewheel position, the drive shaft is able to freely rotate and the load chain wheel is released. The load chain is able to be pulled in both directions. The load chain is able to be moved into the desired working position and pretensioned by rotating the handwheel or by pulling on the idle strand.

In at least one embodiment, a release spring is incorporated between the ratchet wheel and the pressure disk, wherein the spring force of the release spring assists the opening movement of the load pressure brake.

### BRIEF DESCRIPTION OF THE DRAWINGS

Further advantages, features, properties and aspects of embodiments of the present disclosure are the subject matter of the following description. Preferred design variants are shown in diagrammatic figures. They serve for simple understanding of the described embodiments. In the figures:

FIG. 1 shows a lever hoist in a side view, according to at least one embodiment;

FIG. 2 shows the lever hoist in an exploded view of the components thereof, according to at least one embodiment;

FIG. 3 shows a longitudinal section through the lever hoist, according to at least one embodiment; and

FIG. 4 shows the lever hoist according to the view of FIG. 3 with the handwheel and the ratchet wheel in the disengaged position, according to at least one embodiment.

### DETAILED DESCRIPTION

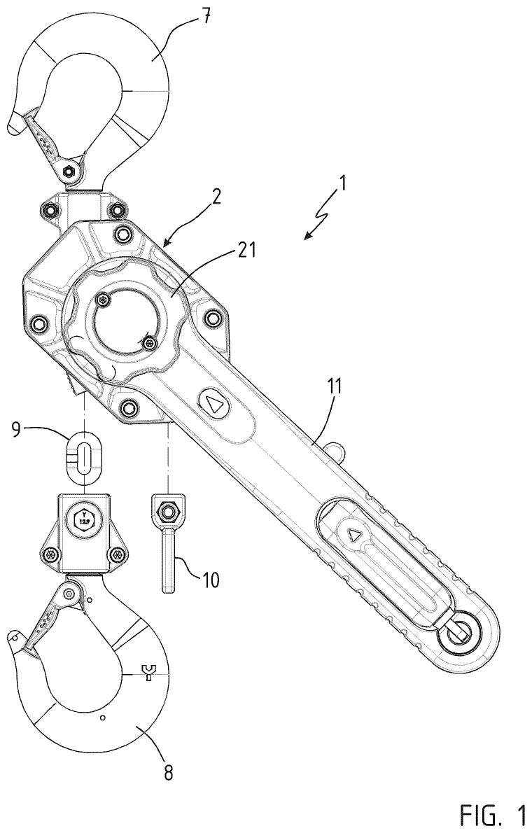

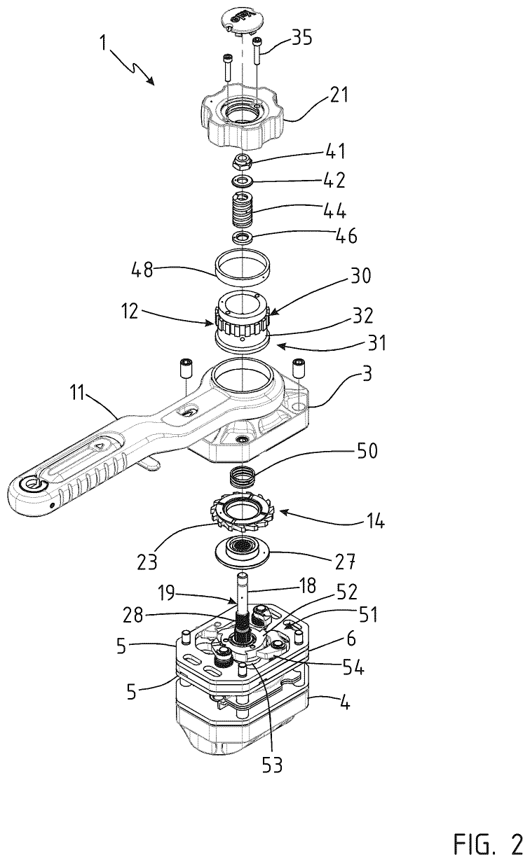

FIG. 1 to FIG. 4 show a hand-actuated lever hoist 1 according to the disclosure. A constituent part of the lever hoist 1 is a housing 2 which is made up of a plurality of housing parts 3, 4 and side plates 5 and a spacer frame 6. The lever hoist 1 has a support hook 7 as an upper fastening element and a load hook 8 as a lower stop element. The support hook 7 and the load hook 8 are indirectly connected together via the housing 2. The load hook 8 is attached to one end of a load chain 9. A chain end piece 10 is provided at the other end of the load chain 9. The load chain 9 is able to be moved via a traction drive. The traction drive includes a drive with a hand lever 11, a ratchet wheel 12 and a switchable ratchet mechanism 13, a load pressure brake 14, a load chain wheel 15 and a gear mechanism 16. A pawl body 17 in the form of a pawl rod is spring-loaded and longitudinally displaceably mounted in the hand lever 11. The hand lever 11 with the pawl body 17 and the ratchet wheel 12 are located on an end portion 18 of a drive shaft 19 which passes through the load pressure brake 14 and the load chain wheel 15. The gear mechanism 16 is located at the other end portion 20 of the drive shaft 19, the gear mechanism being connected to the load chain wheel 15 in a torque-transmitting manner. A handwheel 21 serves for the axial displacement of the ratchet wheel 12 on the drive shaft 19 in order to actuate a freewheel mechanism 22 of the lever hoist 1.

The load pressure brake 14 has a ratchet wheel disk 23 which is provided with teeth on its outer circumference. The ratchet wheel disk 23 is provided on either side with friction elements 24 in the form of friction linings. The load pressure brake 14 has two pawls 25 which are pivotably movably mounted in the housing 2 on the side plate 5 and which are pushed against the ratchet wheel disk 23 by the action of the ratchet hook springs 26. A pressure disk 27, on which the ratchet wheel disk 23 is mounted, also forms part of the load pressure brake 14. The ratchet wheel 12 is axially displaceable on a threaded portion 29 of the drive shaft 19 having a brake thread 28.

The task of the load pressure brake 14 is to hold the load carried by the lever hoist 1 when the ratchet wheel 12 is at a standstill. Then the ratchet wheel 12 is pushed against the pressure disk 27 via the ratchet wheel disk 23 and the incorporated friction elements 24. The pawls 25 are located in the circumferential recesses of the ratchet wheel disk 23. If the ratchet wheel 12 is rotated in the lifting direction, the pawls 25 slide over the teeth of the ratchet wheel disk 23 until the ratchet wheel 12 comes to a standstill. Then the pawls 25 are latched back into the recess of the ratchet wheel disk 23. When the load is lowered, the ratchet wheel 12 is rotated in the opposing direction, whereby the ratchet wheel 12 slides axially on the brake thread 28 of the drive shaft 19 and the frictional contact with the friction elements 24 of the ratchet wheel disk 23 and the pressure disk 27 is released. The load is able to then be lowered until the drive shaft 19, which continues to rotate, compensates again for the axial play.

The ratchet wheel 12 has drive teeth 30 on the outer circumference. The drive teeth 30 include teeth axially extending in the longitudinal direction with grooves arranged therebetween. The region with the drive teeth 30 extends over a first front longitudinal portion of the ratchet wheel 12, viewed from the handwheel 21. An untoothed freely rotated disengagement portion 32 is provided between the drive teeth 30 and the end 31 of the ratchet wheel 12 on the pressure disk side. The untoothed freely rotated disengagement portion 32 extends from the drive teeth 30 over a second rear longitudinal portion of the ratchet wheel 12. At the end 31, the ratchet wheel 12 has a radial collar which is widened relative to the diameter of the disengagement portion 32.

The ratchet wheel 12 is configured to be hollow-cylindrical and has a hollow chamber 33. The handwheel 21 is fixed on the front face to the circumferential outer wall 34 of the ratchet wheel 12 by means of fastening screws 35. A central through-opening 37 with an internal thread 38 is located in the bottom 36 of the ratchet wheel 12. The ratchet wheel 12 moves on the brake thread 28 of the drive shaft 19 by means of the internal thread 38.

The drive shaft 19 passes through the ratchet wheel 12 and protrudes with its end portion 18 through the ratchet wheel 12 into a central recess 39 in the handwheel 21. An outer stop 40 is provided at the free end of the drive shaft 19. The outer stop 40 functions as an end stop and is formed by a locking nut 41 and a washer 42 arranged on the end of the drive shaft 19. The locking nut 41 is screwed onto a threaded portion on the end of the drive shaft 19. A longitudinal portion 43 of the drive shaft 19 is designed to be smooth between the brake thread 28 and the outer stop 40.

A damping spring 44 is arranged on the longitudinal portion 43. The damping spring 44 is a compression spring which extends concentrically around the longitudinal portion 43 of the drive shaft 19 between the outer stop 40 and an inner stop 45. The damping spring 44 is supported with its end oriented toward the brake thread 28 on the inner stop 45. The inner stop 45 is formed by a supporting ring 46 which is arranged on the drive shaft 19 in front of the brake thread 28.

The spring force F1 of the damping spring 44 acts counter to the opening movement of the load pressure brake 14. The spring force F1 pushes the load pressure brake 14 closed.

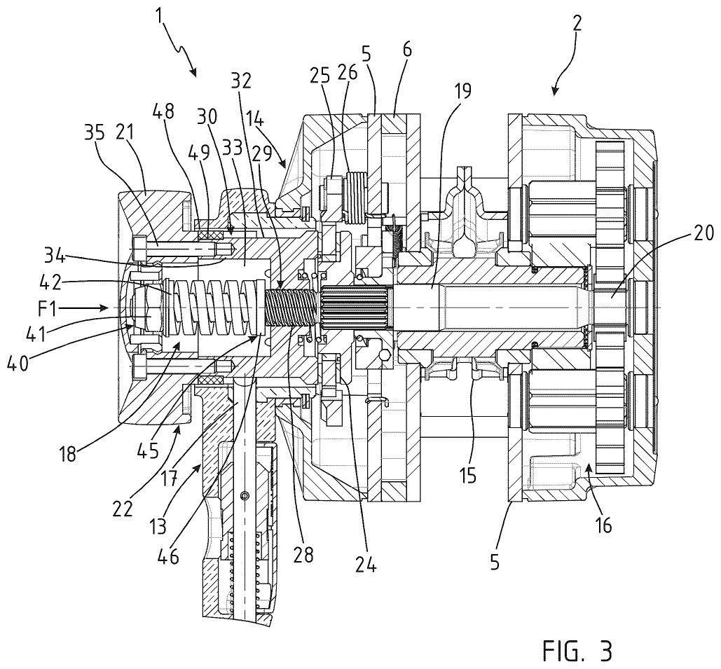

In normal operation or uninterrupted operation, the pawl body 17 of the ratchet mechanism 13 engages in the grooves between the teeth of the drive teeth 30. This operating state is shown in FIG. 3. In normal operation, the load torque is transmitted via the drive shaft 19 to the load pressure brake 14. Due to the brake thread 28, the relative rotation between the drive shaft 19 and the ratchet wheel 12 leads to an axial force which causes the ratchet wheel disk 23 to be clamped between the pressure disk 27 and the ratchet wheel 12.

For releasing the load pressure brake 14, the hand lever 11 is engaged by means of the pawl body 17 in the drive teeth 30 of the ratchet wheel 12. An axial displacement of the ratchet wheel 12 is brought about by rotating the ratchet wheel 12. As a result, the brake torque is reduced or canceled. A load is able to be lowered until the axial force and the resulting brake torque is built up again.

If the continuous free sliding of the load and thus the continuous closing of the load pressure brake 14 is interrupted, for example if the load chain 9 is knotted or jammed, a dangerous situation is able to occur. This is the case if the user does not identify the situation and attempts to lower the load counter to the resistance.

The ratchet wheel 12 is axially displaced in the direction toward the outer stop 40 of the drive shaft 19. Before the ratchet wheel 12 is coupled against rotation to the outer stop 40, however, in which full torque would be introduced via the end stop, the hand lever 11 is decoupled.

To this end, the damping spring 44 is positioned between the ratchet wheel 12 and the outer end stop 40. The damping spring 44 permits a greater axial displacement of the ratchet wheel 12 on the brake thread 28 away from the pressure disk 27. The damping spring 44 is compressed here.

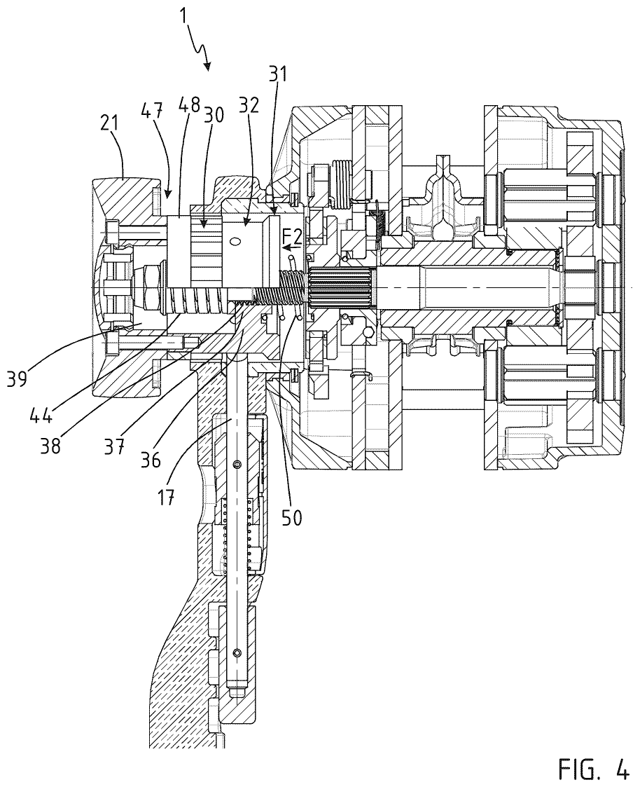

The ratchet wheel 12 is displaced against the pressure of the damping spring 44 until the pawl body 17 is disengaged from engagement with the drive teeth 30 and is displaced into the region of the disengagement portion 32. The flux of force is interrupted in this position. This operating state is shown in the view of FIG. 4.

The ratchet wheel 12 and therewith the handwheel 21 are shifted to the left in the image plane. The damping spring 44 is compressed. In this position, torque is no longer able to be transmitted and the hand lever 11 rotates freely.

At the same time, the handwheel 21 which is connected to the ratchet wheel 12 is disengaged to the side and an indicator 47 in the form of an indicator ring 48 is visible. The indicator ring 48 is arranged externally on a socket portion 49 of the ratchet wheel 12. In the disengaged position, the indicator ring 48 protrudes relative to the housing part of the hand lever 11 encompassing the ratchet wheel 12. By its coloring, the indicator ring 48 visualizes that the flux of force is interrupted and the hand lever 11 is disengaged and decoupled from the regular operating position.

By rotating the handwheel 21 clockwise, the hand lever 11 is able to be coupled again. The ratchet wheel 12 is again displaced in the direction of the pressure disk 27 until the pawl body 17 comes into engagement again with the drive teeth 30 so that the lever hoist 1 is set into the normal operating state.

In order to actuate the freewheel mechanism 22 in addition, the axial spacing between the ratchet wheel 12 and the pressure disk 27 is able to be increased by rotating the handwheel 21, such that the pawl body 17 comes out of engagement with the drive teeth 30. A release spring 50 is incorporated between the ratchet wheel 12 and the pressure disk 27. The spring force F2 of the release spring 50 acts outwardly in the direction of the end 18 of the drive shaft 19 or the handwheel 21 and assists the opening movement of the load pressure brake 14.

In addition to the standard load pressure brake 14, the lever hoist 1 has a safety brake 51. The task of the safety brake 51 is to carry out an emergency braking in extreme situations, such as occurrence of a high rotational speed of the drive shaft 19 that the load pressure brake 14 no longer grips due to inertia.

The safety brake 51 includes a ratchet disk 52 with ratchet teeth and a control disk 53 with control cams and arrestor hooks 54. The arrestor hooks 54 are pivotably movably arranged on the side plate 5 of the lever hoist 1. The ratchet disk 52 and the control disk 53 are rotatable relative to one another. In normal operation of the lever hoist 1, the arrestor hooks 54 are guided via the control cams of the control disk 53 such that the pawl contours thereof do not engage in the ratchet disk 52. When a certain excessive rotational speed is exceeded, the arrestor hooks 54 are lifted away from the control disk 53, as a result of mass inertia and the acting acceleration forces, and engage in the ratchet teeth of the ratchet disk 52. As a result, the ratchet disk 52 is stopped and therewith also the drive shaft 19 by a positive connection. A further rotation of the load chain wheel 15 is prevented.

The foregoing description of some embodiments of the disclosure has been presented for purposes of illustration and description. The description is not intended to be exhaustive or to limit the disclosure to the precise form disclosed, and modifications and variations are possible in light of the above teachings. The specifically described embodiments explain the principles and practical applications to enable one ordinarily skilled in the art to utilize various embodiments and with various modifications as are suited to the particular use contemplated. Various changes, substitutions and alterations can be made hereto without departing from the spirit and scope of the disclosure.

1-8. (canceled)

9. A lever hoist, comprising:
a housing, in which a load chain wheel and a drive shaft configured to drive the load chain wheel via a gear mechanism, are rotatably mounted;
a lever connected to the drive shaft, a drive torque transmittable to the drive shaft via the lever;
a load chain connected to the load chain wheel, the load chain movable via the load chain wheel;
a load pressure brake comprising:
a pressure disk and a ratchet wheel which are arranged on the drive shaft, and
a ratchet wheel disk between the pressure disk and the ratchet wheel, wherein
the ratchet wheel comprising an internal thread is axially displaceable on a threaded portion of the drive shaft having a brake thread, and
the ratchet wheel further comprises:
drive teeth on an outer circumference of the ratchet wheel for engagement of a pawl body, and
an untoothed disengagement portion on the outer circumference between the drive teeth and an end of the ratchet wheel facing the pressure disk; and
a damping spring on a drive-side longitudinal portion of the drive shaft, between the brake thread and an outer stop of the drive shaft.

10. The lever hoist according to claim 9, wherein a spring force of the damping spring acts counter to an opening movement of the load pressure brake.

11. The lever hoist according to claim 9, wherein the damping spring has an end oriented toward the brake thread and supported on an inner stop of the drive shaft.

12. The lever hoist according to claim 9, further comprising a display, the display being visible in response to (i) the ratchet wheel being axially displaced counter to a spring force of the damping spring on the drive shaft and (ii) the pawl body being disengaged from engagement with the drive teeth.

13. The lever hoist according to claim 12, wherein the display comprises an indicator ring on a socket portion of the ratchet wheel.

14. The lever hoist according to claim 9, further comprising a freewheel mechanism, the freewheel mechanism being configured to increase axial spacing between the ratchet wheel and the pressure disk.

15. The lever hoist according to claim 14, wherein the freewheel mechanism comprises a handwheel coupled to the ratchet wheel, and configured to displace the ratchet wheel axially on the drive shaft.

16. The lever hoist according to claim 9, further comprising a release spring between the ratchet wheel and the pressure disk, wherein a spring force of the release spring assists an opening movement of the load pressure brake.
